(19) United States
(12) Patent Application Publication
(10) Pub. No.: US 2009/0093379 A1
(43) Pub. Date: Apr. 9, 2009

(54) Spot Pin, Spot Device, Liquid Spotting Method, and Method of Manufacturing Unit for Biochemical Analysis

(75) Inventor: Daisuke Komada, Kitami-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 11/914,447

(22) PCT Filed: Apr. 28, 2006
(86) PCT No.: PCT/JP2006/309060

§ 371 Date: Nov. 14, 2007

(30) Foreign Application Priority Data
May 17, 2005 (JP) 2005-144394
Nov. 30, 2005 (JP) 2005-347379

(51) Int. Cl. C40B 50/14; C40B 60/14

(52) U.S. Cl. 506/30; 506/40

(57) ABSTRACT

The present invention relates to a spot pin (2) including: a liquid holding portion (21) including a tubular portion and defining a liquid holding space (27) for holding a liquid; and an upper limit position definition portion positioned in a middle of the liquid holding portion (21) in an axial direction and defining the upper limit position of the liquid held in the liquid holding portion (21). The upper limit position definition portion has one or a plurality of outside air communication holes (24) communicated with the liquid holding space (27) and opened in the circumferential surface of the liquid holding portion (21).

### TECHNICAL FIELD

The present invention relates to a spot device for spotting a liquid onto a spotted surface, a spot pin used for the spot device, a liquid spotting method using the spot pin, and a method of manufacturing a unit for biochemical analysis.

### BACKGROUND ART

There has been a method using a unit for biochemical analysis, such as a biochip (see Patent Documents 1 to 3) as a method of analyzing the base sequence of DNA. Probe DNA having a known base sequence is spot-fixed onto a substrate of the biochip. On such biochip, the probe DNA is brought into contact with sample DNA labeled with a fluorescent material so that complementary strand DNA of the probe DNA included in the sample DNA is combined with the probe DNA. DNA uncombined with the probe DNA is removed by washing. The fluorescent material labeling the complementary strand DNA is excited by light energy, thereby detecting its excitation light and then, target DNA.

As described above, the probe DNA is fixed onto the substrate of the biochip. In the fixation, a reagent including the probe DNA is spotted onto the substrate. A spot device holding a plurality of spot pins for holding the reagent on a head is used for spotting of the reagent.

FIG. 19 shows an important part around a head of a typical spot device. A plurality of spot pins 91 are held on a head 90. Each of the spot pins 91 is formed in pipe shape having an inner space 92 exerting the capillary force. The edge of the spot pin 91 is immersed into a reagent so that the reagent is sucked and held in the inner space 92 by the capillary force exerted in the inner space 92.

Patent Document 1: Japanese Patent Application Laid-Open (JP-A) No. 2002-355036

Patent Document 2: Japanese Patent Application Laid-Open (JP-A) No. 2004-4083

Patent Document 3: Japanese Patent Application Laid-Open (JP-A) No. 2004-354123

### DISCLOSURE OF THE INVENTION

### Problems to be Solved by the Invention

In general, the amount of a liquid held in the spot pin 91 is controlled according to time to immerse the spot pin 91 into the liquid. However, the amount of the liquid sucked and held in the spot pin 91 depends, not only on the time to immerse the spot pin 91 into the liquid, but also on the viscosity and temperature of the liquid. Therefore, the time to immerse the spot pin 91 into the liquid is only controlled, which is difficult to precisely control the amount of the liquid sucked and held in the spot pin 91. The inner space 92 of the pipe-shaped spot pin 91 shown in FIG. 19 is opened on the upper and lower sides. Accordingly, while the spot pin 91 is immersed into the liquid, the liquid is sucked in the inner space 92 unless it reaches an upper opening. It is difficult to hold a target amount of the reagent.

When the amount of the liquid sucked and held in the spot pin 91 is smaller than the target amount and liquid drop spotting is performed plural times by one sucking, a predetermined number of times of spotting cannot be achieved so that the liquid need to be sucked up additionally. Such disadvantage can be avoided by holding the amount of the liquid much larger than a necessary amount of the liquid in the spot pin 91. In this case, the amount of spotting can be excessive and varied. When the kind of the liquid to be spotted is changed in the spot pin 91, the amount of the liquid remaining in the spot pin 91 is increased. Thus, the amount of the liquid to be wasted is increased, which is uneconomical.

At sucking the liquid in the spot pin 91, when the spot pin 91 is pulled out from the liquid, air is sucked in the spot pin 91 by the capillary force exerted in the spot pin 91 so that an air gap can occur on the edge side of the spot pin 91. In this state, when the edge of the spot pin 91 is brought into contact with a spotted surface, the liquid cannot be discharged from the spot pin 91. Accordingly, the spotting of the liquid can be substantially impossible.

An object of the present invention is to provide a spot pin which can stabilize the amount of sucking and fix the number of times of spotting by one sucking, a spot device using the same, a liquid spotting method, and a method of manufacturing a unit for biochemical analysis.

### Means for Solving the Problems

A spot pin provided in a first aspect of the present invention includes: a liquid holding portion including a tubular portion for defining a liquid holding space for holding a liquid; and an upper limit position definition portion positioned in a middle of the liquid holding portion in an axial direction and defining the upper limit position of the liquid held in the liquid holding portion.

The tubular portion may be in cylindrical, square tubular, or elliptical tubular shape or may be in other shape.

The upper limit position definition portion has one or a plurality of outside air communication holes communicated with the liquid holding space and opened in a circumferential surface, of the liquid holding portion.

The outside air communication hole is penetrated in a direction crossing the axial direction and has the largest width dimension, viewed in the axial direction, equal to or larger than the inner diameter of the liquid holding portion. The outside air communication hole may be tapered in such a manner that its diameter is increased outward from the liquid holding space, viewed in the axial direction. The plurality of outside air communication holes may include first and second outside air communication holes opposite each other by interposing the liquid holding space therebetween.

An inside opening of the outside air communication hole has a dimension in the axial direction larger than that in the direction crossing the axial direction.

A lower end of the inside opening of the outside air communication hole is formed in linear shape crossing the axial direction, viewed in a penetration direction of the outside air communication hole.

Preferably, the spot pin of the present invention further includes a seal member arranged on the upper side in the liquid holding space.

The spot pin of the present invention has a through hole penetrated in the axial direction. In this case, preferably, the through hole includes the liquid holding space for exhibiting the capillary force and a large-diameter penetration portion having a diameter larger than that of the liquid holding space and configuring the upper limit position definition portion which does not exhibit the capillary force or hardly exhibits the capillary force.

Preferably, the liquid holding space is formed in such a manner that its cross-sectional area is made smaller toward a spotting surface to be contacted with a spotted surface. The liquid holding space can have first and second reserving spaces having a different cross-sectional area in the direction crossing the axial direction. In this case, the first reserving space is arranged so as to be closer to the spotting surface side than to the second reserving space and has a cross-sectional area smaller than that of the second reserving space.

Preferably, the liquid holding portion is formed in such a manner that its wall thickness is increased toward the spotting surface and can also be formed in such a manner that at least part of it has translucency. The portion having translucency of the liquid holding portion is formed of zirconia ceramic. The wall thickness of the portion is 0.5 mm or below.

Here, the term “translucency” for the portion having translucency in the liquid holding portion means a characteristic of visually checking the presence (amount) of the liquid in the liquid holding portion. Such translucency can be achieved in such a manner that at least part of the liquid holding portion has a visual transmissivity of 3% or above.

Preferably, the entire spot pin of the present invention is formed of zirconia ceramics.

The spot pin of the present invention further may have one or a plurality of protrusions provided on the spotting surface and surrounding an edge opening in the liquid holding space. The protrusion is formed in annular shape.

A second aspect of the present invention provides a spot device including: a spot pin according to the first aspect of the present invention; a moving mechanism for moving the spot pin in an axial direction; and a control unit for controlling the operation of the moving mechanism.

The spot device of the present invention further includes a liquid supply mechanism for supplying a liquid into the liquid holding space of the spot pin.

The liquid supply mechanism supplies, as a liquid, a specimen solution, reagent, or washing solution.

A third aspect of the present invention provides a liquid spotting method including the steps of: holding a liquid in a liquid holding space of a spot pin according to the first aspect of the present invention; and bringing a spotting surface of the spot pin into contact with a spotted surface to separate the spotting surface from the spotted surface for spotting the liquid in the liquid holding space onto the spotted surface.

Preferably, the liquid spotting method further includes the step of discharging the liquid remaining in the liquid holding space after the spotting step.

A fourth aspect of the present invention provides a method of manufacturing a unit for biochemical analysis, which fixes a reagent onto a substrate, including the steps of: holding the reagent in a liquid holding space of a spot pin according to the first aspect of the present invention; and bringing a spotting surface of the spot pin into contact with the surface of the substrate to separate the spotting surface from the substrate for spotting the reagent in the liquid holding space onto the surface of the substrate.

### EFFECT OF THE INVENTION

The spot pin according to the present invention has the upper limit position definition portion for defining the upper limit position of the liquid held in the liquid holding portion so as to stabilize the amount of the liquid held in the liquid holding space. When the upper limit position definition portion is formed as the outside air communication hole, the liquid holding space is opened in a forming position of the outside air communication hole. Therefore, the capillary force is suddenly weakened (substantially disappears) in the forming portion so as to prevent the liquid from being moved (sucked) above the forming position of the outside air communication hole. When the upper limit position definition portion is formed as the large-diameter penetration portion, the capillary force does not substantially occur in the large-diameter penetration portion so as to prevent the liquid from being moved (sucked) upwardly of the liquid holding space. In the present invention, the upper limit position of the liquid held in the liquid holding portion can be substantially defined by the upper limit position definition portion (e.g., the outside air communication hole and the large-diameter penetration portion). Thus, the amount of the liquid held in the spot pin can be stabilized.

When the amount of the liquid held in the spot pin is stabilized, the amount of the liquid held in the liquid holding space by one operation can be closer to an amount necessary for achieving a predetermined number of times of spotting. Therefore, the disadvantage caused when the held liquid is excessive can be prevented. An excessive amount of spotting can be prevented so as to avoid variation in the amount of spotting. The amount of the liquid remaining in the spot pin is decreased. Thus, when the kind of the liquid to be spotted is changed in the spot pin, the amount of the liquid to be wasted is decreased, which is economically advantageous.

In the spot pin of the present invention, when the liquid is sucked and held in the liquid holding space in which the spotting surface of the spot pin is immersed into the liquid, occurrence of any air gap on the spotting surface side in the liquid holding space can be prevented. When the liquid holding space is filled with the liquid, upward movement of the liquid is limited by the upper limit position definition portion. Therefore, when the spot pin is pulled out in the state that the spotting surface of the spot pin is immersed into the liquid to be sucked, the force attempting to suck the gas in the liquid holding space becomes significantly small. Accordingly, when the spot pin immersed into the liquid is pulled out, the possibility of sucking the gas in the liquid holding space and the amount of the gas to be sucked are significantly reduced. In the operation of sucking the liquid in the spot pin, occurrence of any air gap on the spotting surface side in the liquid holding space of the spot pin thus can be prevented.

The liquid holding portion formed in cylindrical shape is harder to expose the liquid to outside air atmosphere (a region to be exposed is small) than the liquid holding portion formed in slit shape. Evaporation, deterioration, and contamination of the liquid in the spot pin thus can be prevented. The upper limit position definition portion is configured by the outside air communication hole opened in the circumference surface of the liquid holding portion or the large-diameter penetration portion positioned on the upper side in the liquid holding space. Thus, the above effect can be obtained by a relatively easy configuration and the liquid holding space (capillary region) of the liquid holding portion can be defined. In other words, the forming position of the outside air communication hole or the lower end position of the large-diameter penetration portion is appropriately selected to select the amount of the liquid to be held in the spot pin.

In the spot pin of the present invention, the outside air communication hole is formed in such a manner that the largest width dimension viewed in the axial direction is above the inner diameter of the liquid holding portion. Accordingly, when the liquid is sucked and held in the liquid holding space, occurrence of any air gap on the spotting surface side in the liquid holding space can be prevented more reliably. The largest width dimension of the outside air communication hole viewed in the axial direction is greatly secured. The missing in the inner surface of the liquid holding portion in the forming position of the outside air communication hole can be increased. Thus, the capillary force occurring in the missing portion (outside air communication hole) can be reduced more reliably. The force moving the liquid above the outside air communication hole can be suppressed. Therefore, when the liquid holding space is filled with the liquid to pull out the spot pin immersed into the liquid, the possibility of sucking the gas in the liquid holding space and the amount of the gas to be sucked are significantly reduced.

This means that in the state that the liquid holding space is filled with the liquid, the upward force (sucking force) exerted on the liquid in the liquid holding space is reduced and when the spotting surface of the spot pin is brought into contact with the spotted surface, the liquid in the liquid holding space of the spot pin thus can be spotted more reliably by the capillary force occurring between the spotting surface of the spot pin and the spotted surface. Accordingly, in the state that the liquid holding space is filled with the liquid (initial state), occurrence of any spotting failure of the liquid when the spotting surface of the spot pin is brought into contact with the spotted surface (the amount of spotting is too small or spotting itself cannot be done) can be prevented more reliably.

In the spot pin of the present invention, the spot pin has the plurality of outside air communication holes and the plurality of outside air communication holes include first and second outside air communication holes opposite each other by interposing the liquid holding space therebetween. Even in this case, the inner surface of the liquid holding portion configuring the upper end position in the liquid holding space can be greatly missing. In the configuration, occurrence of any air gap can be appropriately prevented. When the spot pin has the first and second outside air communication holes opposite each other, the inner surface of the liquid holding portion is greatly missing, the inner surface is cut into two regions, and the area of the inner surface becomes small. In the state that the liquid is held in the liquid holding space, the liquid is hard to move upward along the inner surface. As a result, after the liquid is held in the liquid holding space, upward movement of the liquid in the liquid holding space can be appropriately prevented and sucking of the air in the spotting surface side in the liquid holding space can be prevented.

In the spot pin of the present invention, the outside air communication hole is tapered in such a manner that its diameter is increased outward from the liquid holding space. Accordingly, the portion of the outside air communication hole opened to outside is wide-mouthed. Thus the liquid can be easily put into the liquid holding space using the outside air communication hole. The liquid may be directly put into the liquid holding space via the outside air communication hole or by connecting a tube to the outside air communication hole. In either case, the opening portion of the communication hole to be an entrance of the liquid or the connection inlet of the tube is wide-mouthed. Thus, the liquid can be put into the liquid holding space easily and more reliably.

In the spot pin of the present invention, the liquid holding space is tapered in such a manner that its cross-sectional area is made smaller toward the spotting surface. Accordingly, the capillary force is increased toward the spotting surface. Thus, the liquid held in the liquid holding space can be drawn to the spotting surface end side. As a result, in the sucking step, occurrence of any air gap on the spotting surface side in the liquid holding space can be prevented. In the spotting step, when the liquid in the liquid holding space is gradually reduced by repeated spotting, the liquid can continue to exist on the spotting surface side. Therefore, more reliable spotting can be realized.

In the spot pin of the present invention, the dimension of the inside opening of the outside air communication hole in the axial direction is larger than that in the direction crossing the axial direction. Accordingly, the movement of the liquid held in the liquid holding space above the outside air communication hole (inside opening) can be appropriately prevented. In particular, the lower end of the inside opening of the outside air communication hole formed in linear shape crossing the axial direction can prevent movement of the liquid above the outside air communication hole (inside opening) more reliably than the lower end of the inside opening formed in arc shape.

In the spot pin of the present invention, the liquid holding space has the first reserving space arranged on the spotting surface side and the second reserving space having a cross-sectional area larger than that of the first reserving portion. Accordingly, the wall thickness on the edge side (the portion defining the first reserving space of the liquid holding portion) of the spot pin having a uniform outer diameter dimension is relatively increased. Thus, the mechanical strength of the edge on which a large load acts in spotting of the liquid can be sufficiently secured and the entire volume of the liquid holding space (the amount of the liquid held in the liquid holding space) can be greatly secured by the second reserving space. As a result, when spotting is repeated, the shape of the edge of the spot pin is hard to change. Thus, the shape and diameter of spotting can be stabilized for a long time and a large number of times of spotting executed using the liquid held in the liquid holding space can be secured. Therefore, the number of times the liquid is held in the spot pin (liquid holding space) (the number of times the liquid is sucked) can be reduced to improve operability.

In the spot pin of the present invention, the seal member is arranged on the upper side in the liquid holding space. Even in this case, in the state that the liquid holding space is filled with the liquid, movement of the liquid upwardly of the liquid holding space can be prevented. Thus, occurrence of any air gap can be prevented.

The wall thickness of the liquid holding portion is formed so as to be increased toward the edge. Thus, the mechanical strength at the end on the spotting surface side of the spot pin (liquid holding portion) on which a large load acts in spotting of the liquid can be sufficiently secured. Therefore, in the spot pin of the present invention, when spotting is repeated, the shape of the end of the spot pin is hard to change. Thus, the shape and diameter of spotting can be stabilized for a long time.

The portion having translucency is provided in the liquid holding portion. Accordingly, the height and position (amount) of the liquid held in the liquid holding space can be optically checked (e.g., visually checked). Therefore, the processing management and the quality management in the sucking step and the spotting step can be easy. The portion having translucency is formed of zirconia ceramics and its wall thickness is set in the range of 0.03 to 0.5 mm. Accordingly, the height and position (amount) of the liquid held in the liquid holding space can be sufficiently checked. In addition, the mechanical strength and the elastic deformability of the spot pin itself can be sufficiently secured. When the entire spot pin is formed of zirconia ceramics, the mechanical strength and the elastic deformability of the entire spot pin can be sufficiently secured. Thus the spot pin has sufficient durability to a large load acting in repeated spotting. Therefore, occurrence of any damage to the spot pin itself can be prevented for a long time and occurrence of change in the shape on the edge of the spot pin can be prevented. Thus, the shape and diameter of spotting which are stable for a long time can be maintained.

One or a plurality of protrusions surrounding an edge opening in the liquid holding space are formed on the spotting surface of the liquid holding portion. Accordingly, the spotting surface of the spot pin can be brought into contact with the spotted surface more reliably. When the liquid is brought into contact with the spotted surface, the liquid is immersed along the protrusion by the surface tension of the liquid. As a result, when the spotting surface of the spot pin (liquid holding portion) is brought into contact with the spotted surface, the liquid can be brought into contact with the spotted surface more reliably. Thus, occurrence of any spotting failure can be prevented more reliably.

The spotting surface having the protrusion formed in annular shape can position the spotting liquid held in the liquid holding space below more reliably than the spotting surface not formed with the protrusion. When the spotting surface of the liquid holding portion is brought into contact with the spotted surface, the liquid can be easily brought into contact with the spotted surface. The edge opening is surrounded by the plurality of protrusions. Accordingly, when the liquid is brought into contact with the spotted surface, the liquid can be easily spread from between the protrusions adjacent to each other. Thus, the liquid can be spotted more reliably.

When the cylindrical shape is employed as the shape of the tubular portion, the spot pin can be processed relatively easily, which is advantageous from the viewpoint of productivity. When the square tubular shape is employed as the shape of the tubular portion, the cross section in the liquid holding space is rectangular to add the capillary force in the corner portion. Thus, the capillary effect can be obtained more appropriately. When the elliptical tubular shape is employed as the shape of the tubular portion, the spot pin can be processed more easily than the square tubular shape and is more advantageous in obtaining the capillary effect than the cylindrical shape.

The spot device of the present invention has the above-described spot pin and thus can have the effect of the spot pin of the present invention. That is, the spot device of the present invention can stabilize the amount of the liquid held in the spot pin and can prevent occurrence of any air gap and spotting failure.

The spot device has a liquid supply mechanism for supplying a specimen solution, reagent, or washing solution. Accordingly, supply of the liquid into the liquid holding space of the spot pin, and replacement and discharge of the held liquid, and washing of the spot pin can be easily done.

The liquid spotting method of the present invention is performed using the above-described spot pin. The amount of the liquid held in the spot pin is stabilized. Thus, occurrence of any air gap and spotting failure and variation in the amount of spotting can be prevented.

In the step of discharging the liquid remaining in the liquid holding space of the spot pin, in the spot pin of the present invention, the amount of the liquid held in the liquid holding space can be closer to an amount necessary for achieving a predetermined number of times of spotting. Thus, the amount of the liquid remaining in the spot pin is made smaller and the amount of the liquid to be wasted is reduced, which is economically advantageous.

The method of manufacturing a unit for biochemical analysis according to the present invention uses the spot pin of the present invention. Accordingly, variation in the amount of the reagent spotted onto the substrate can be prevented. The amount of the reagent fixed onto the substrate thus can be stabilized. Therefore, in the unit for biochemical analysis obtained by this manufacturing method, variation in the amount of the fixed reagent is less and the measurement accuracy becomes high.

### BRIEF DESCRIPTION OF THE DRAWINGS

FIG. 1 is an overall perspective view of a spot device of assistance in explaining a first embodiment of the present invention.

FIG. 2 is an overall perspective view of assistance in explaining an example of a unit for biochemical analysis to be manufactured in the spot device shown in FIG. 1.

FIG. 3 is a cross-sectional view taken along line III-III of FIG. 2.

FIG. 4 is a cross-sectional view around a head of the spot device shown in FIG. 1.

FIG. 5 is a cross-sectional view of a spot pin.

FIG. 6A is a bottom view of the spot pin, and FIG. 6B is a cross-sectional view of the edge portion of the spot pin.

FIG. 7 is a cross-sectional view taken along line VII-VII of FIG. 5.

FIGS. 8A to 8C are cross-sectional views of assistance in explaining a liquid supply mechanism of the spot device.

FIGS. 9A and 9B are cross-sectional views of assistance in explaining an operation of supplying a liquid to the spot pin.

FIGS. 10A to 10C are cross-sectional views of assistance in explaining a spotting operation using the spot pin.

FIGS. 11A to 11D are cross-sectional views corresponding to FIG. 7 showing other examples of an outside air communication hole.

FIGS. 12A to 12D are front views showing an important part of the spot pin of assistance in explaining other examples of the communication hole and cross-sectional views corresponding to FIG. 7.

FIG. 13 is a cross-sectional view of the spot pin corresponding to FIG. 5 of assistance in explaining a second embodiment of the present invention.

FIG. 14 is a cross-sectional view of the spot pin corresponding to FIG. 5 of assistance in explaining a third embodiment of the present invention.

FIG. 15 is a cross-sectional view of the spot pin corresponding to FIG. 5 of assistance in explaining a fourth embodiment of the present invention.

FIG. 16A is a cross-sectional view of the spot pin corresponding to FIG. 5 of assistance in explaining a fifth embodiment of the present invention, and FIG. 16B is a cross-sectional view of the spot pin corresponding to FIG. 5 of assistance in explaining a sixth embodiment of the present invention.

FIG. 17A is a cross-sectional view of the spot pin corresponding to FIG. 5 of assistance in explaining a seventh embodiment of the present invention, and FIG. 17B is a cross-sectional view in the state of holding the liquid in a liquid holding space.

FIG. 18S is a graph showing the results of the present invention of variation in the number of times of spotting executed by one sucking, and FIG. 18B is a graph showing the results of a comparative example of variation in the number of times of spotting executed by one sucking.

FIG. 19 is a cross-sectional view showing an example of a prior art spot pin.

### DESCRIPTION OF THE REFERENCE NUMERALS

1 Spot device
11 Biochip (unit for biochemical analysis)
12 Substrate (of the biochip)
2, 2A, 2B, 2C, 2′, 2A′, 2B′ Spot pin
21 Liquid holding portion
23 Through hole
23C Large-diameter penetration portion (upper limit position definition portion)
24, 24A, 24B Outside air communication hole (upper limit position definition portion)
26 Ring-like protrusion (protrusion)
26A Protrusion
27 Liquid holding space
27A First reserving space
27B Second reserving space
29′, 29A′, 29B′ Seal member
4 Liquid supply mechanism
50 Z-axis driving mechanism (moving mechanism)
53 Control unit

### BEST MODE FOR CARRYING OUT THE INVENTION

First to seventh embodiments of the present invention will be described below with reference to the drawings.

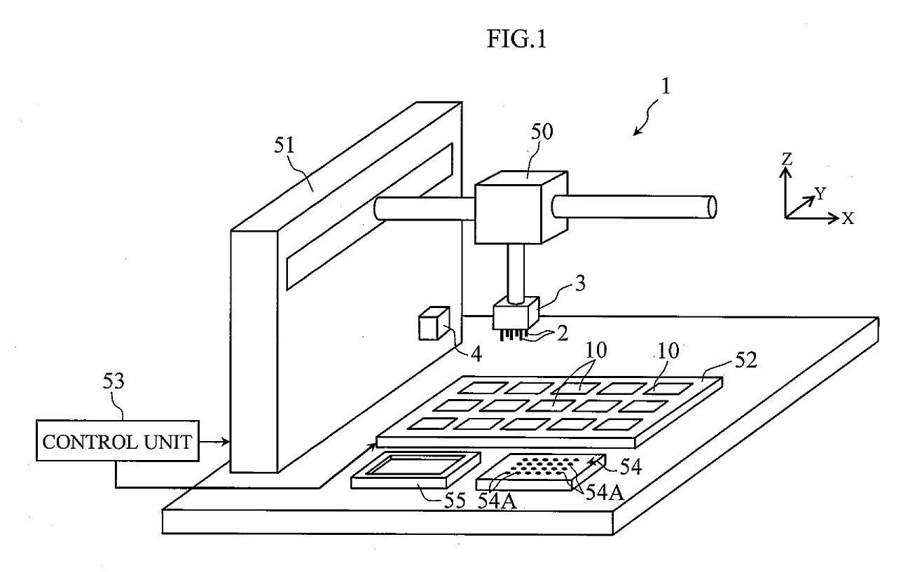

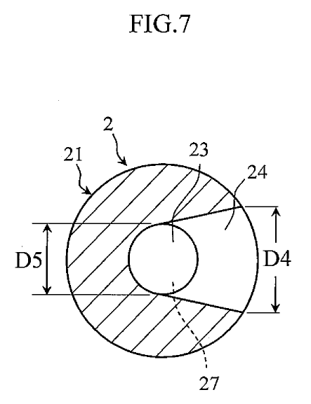

The first embodiment of the present invention will be described with reference to FIGS. 1 to 10.

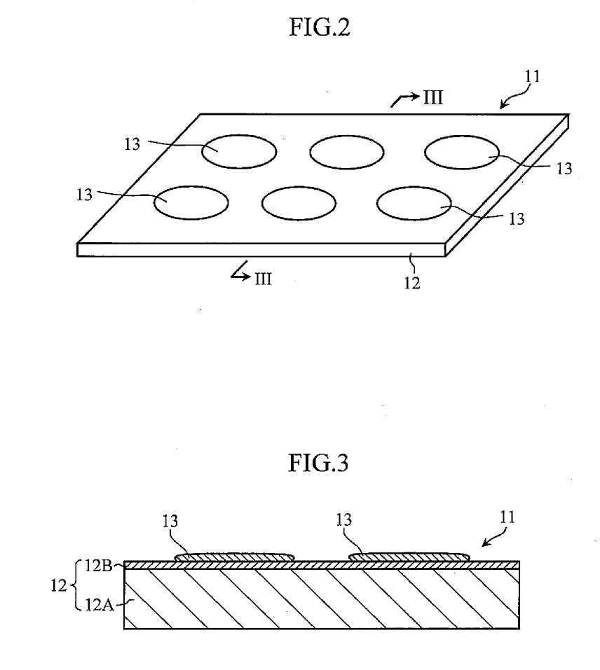

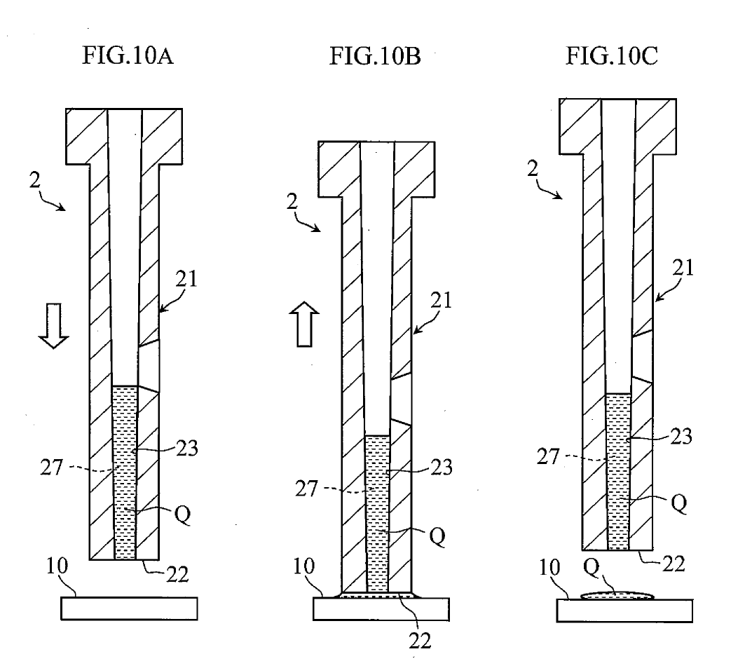

A spot device 1 shown in FIG. 1 performs spotting onto the target portion of a spotted object 10 (see FIGS. 10A to 10C) and is used for manufacturing a unit for biochemical analysis. The unit for biochemical analysis to be manufactured by the spot device 1 is a biochip 11 shown in FIGS. 2 and 3.

The illustrated biochip 11 excites a fluorescent material labeling complementary strand DNA of probe DNA by light energy, thereby detecting its excitation light and then, target DNA. The biochip 11 has a plurality of specimen fixing films 13 on a substrate 12. In the illustrated example, the substrate 12 has a light reflection film 12B on a transparent substrate 12A such as glass. The light reflection film 12B reflects fluorescence emitted from the complementary strand DNA combined with the specimen fixing film 13 and is formed as a metal film having, as the main ingredient, at least one of titanium (Ti), chrome (Cr), nickel (Ni), gold (Au), silver (Ag), platinum (Pt), rhodium (Rh), aluminum (Al), a nickel-chrome (Ni—Cr) alloy, and an iron-chrome-nickel (Fe—Cr—Ni) alloy. The plurality of specimen fixing films 13 each has a base sequence including a known probe DNA and is arrayed in a matrix.

The spot device 1 shown in FIG. 1 has a plurality (six in the drawing) of spot pins 2, a head 3, a liquid supply mechanism 4, a Z-axis driving mechanism 50, an XY-axis driving mechanism 51, a stage 52, a control unit 53, a spotting liquid holding portion 54, and a washing portion 55.

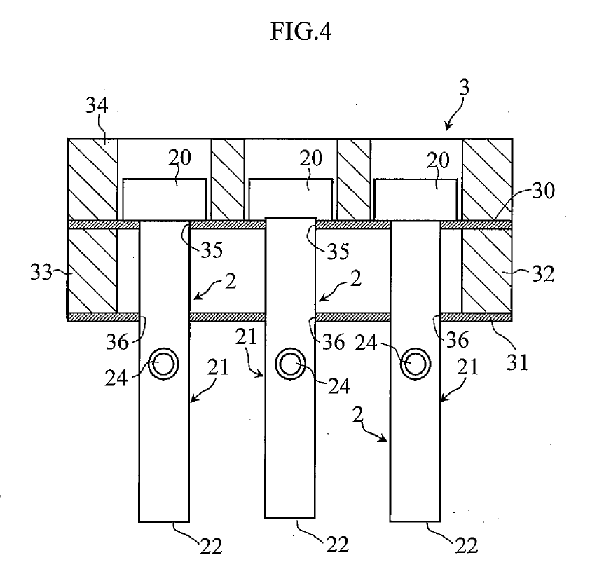

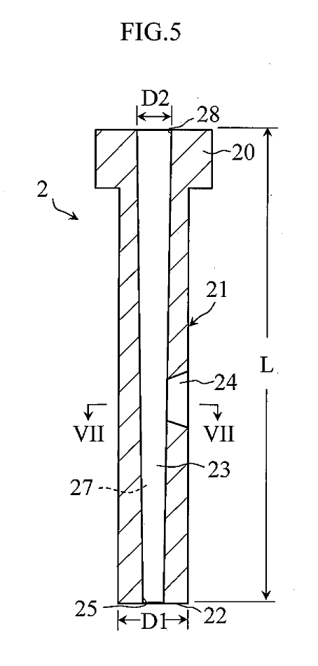

As shown in FIGS. 4 and 5, each of the spot pins 2 holds in its inside a liquid Q such as a reagent to be spotted (see FIG. 4) and has an engaging portion 20 and a liquid holding portion 21.

The engaging portion 20 is a portion used for supporting the spot pin 2 on the head 3 and has an outer shape dimension larger than that of other portions.

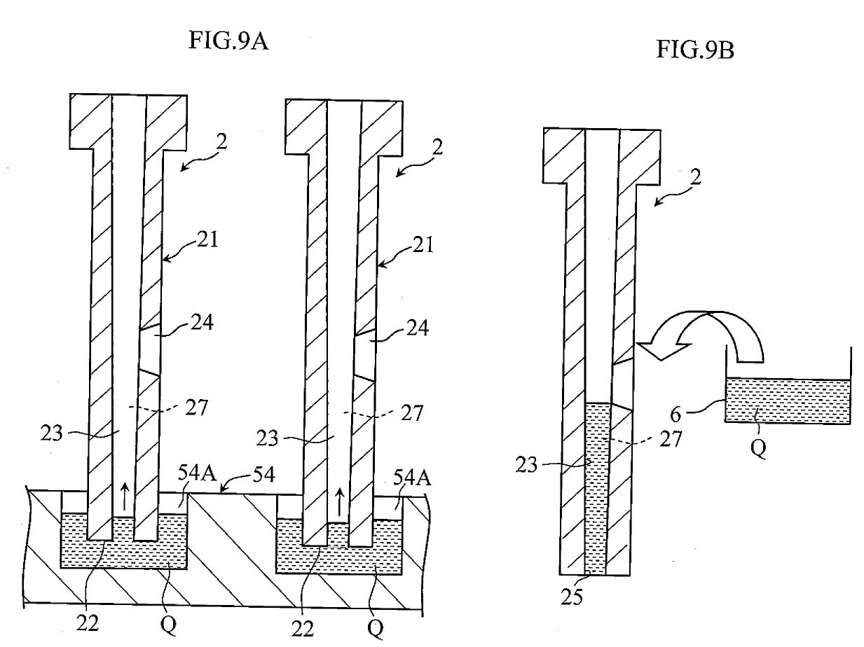

The liquid holding portion 21 exerts the capillary force and sucks in and holds the liquid Q (see FIG. 9A) and is formed in cylindrical shape having a uniform outer diameter dimension. The liquid holding portion 21 has a spotting surface 22, a through hole 23, and an outside air communication hole 24.

The spotting surface 22 is a portion to be brought into contact with the target portion of the spotted object 10 when the liquid Q is spotted onto the target portion of the spotted object 10 and is a portion for defining the shape and spot diameter of the liquid Q spotted by the capillary force exerted between the spotting surface 22 and the target portion (see FIGS. 10A to 10C). The spotting surface 22 is formed in annular shape and its outer diameter D1 is set to, e.g., 0.1 to 5 mm. The shape of the spotting surface 22 is not limited to the annular shape and other shapes can be employed.

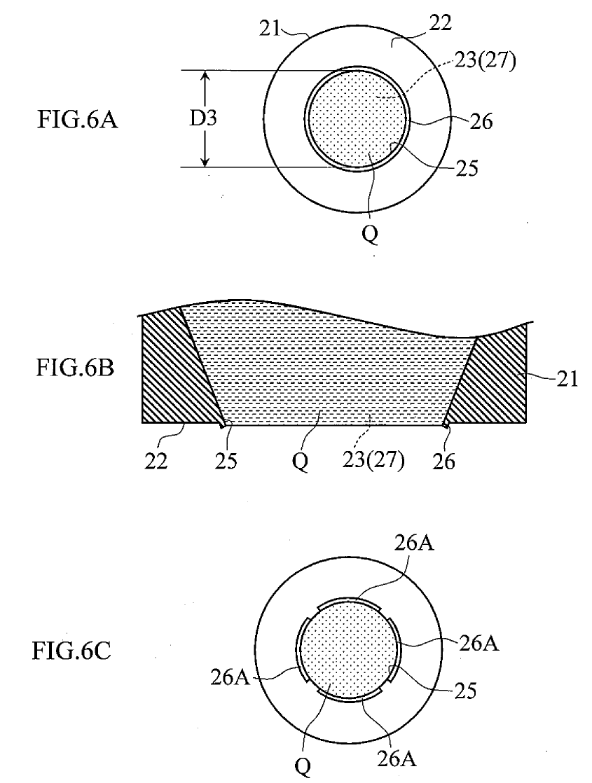

As shown in FIGS. 6A and 6B, the spotting surface 22 has a ring-like protrusion 26 surrounding a lower opening 25 of the through hole 23. The ring-like protrusion 26 reliably brings the edge of the spot pin 2 and the liquid Q held in the liquid holding portion 21 into contact with the spotted object 10 (see FIGS. 1 and 10) and its height is about 0.05 to 0.5 mm.

When such ring-like protrusion 26 is provided and the liquid Q held in the liquid holding portion 21 is brought into contact with the spotted object 10, the liquid Q is penetrated along the ring-like protrusion 26 by the surface tension of the liquid Q. Therefore, when the spotting surface 22 of the liquid holding portion 21 is brought into contact with the spotted object 10, the liquid Q can be reliably brought into contact with the spotted object 10. Thus, occurrence of any spotting failure can be prevented more reliably.

The ring-like protrusion 26 may be formed integrally with the spot pin 2. The ring-like protrusion 26, which is formed as a member different from the spot pin 2, may be joined to the spotting surface 22. The ring-like protrusion 26 is preferably formed using a material exhibiting moderate elastic deformation when brought into contact with the spotted object 10. In place of the ring-like protrusion 26, as shown in FIG. 6C, the lower opening 25 may be surrounded by a plurality of non-ring-like protrusions 26A. Accordingly, when the lower opening 25 is surrounded by the plurality of protrusions 26A, the liquid Q can be easily spread from between the protrusions 26A adjacent to each other. Thus, the liquid Q can be spotted more reliably.

As shown in FIGS. 5 and 6A, the through hole 23 defines a liquid holding space 27 together with the outside air communication hole 24, has a circular cross-section, and is tapered in such a manner that its cross-sectional area is made smaller toward the spotting surface 22. The inner diameter of the through hole 23 is set in the range of, e.g., 0.01 to 1 mm so as to exhibit the capillary action. The taper ratio (=(D2−D3)/L) of the through hole 23 is preferably set in the range of 0.001 to 0.6. Here, D2 is the diameter of an upper opening 28 of the through hole 23, D3 is the diameter of the lower opening 25 of the through hole 23, and L is the length of the through hole 23. When a circular shape is employed as the cross-sectional shape of the through hole 23, processing becomes easy.

The cross-sectional shape of the through hole 23 is not limited to the circular shape and can be elliptical, semicircular, triangular, square, polygonal, or star-shaped. When the semicircular, triangular, square, polygonal, or star shape is employed as the cross-sectional shape of the through hole 23, the capillary force in the corner portion is added so as to obtain the capillary effect more appropriately. The through hole 23 in elliptical cross-sectional shape can process the spot pin 2 more easily than the through hole 23 having the corner portion and is more advantageous in obtaining the capillary effect than the through hole 23 in the circular cross-sectional shape.

When the through hole 23 is tapered in such a manner that its diameter is decreased toward the spotting surface 22, the capillary force is strengthened toward the lower opening 25 side of the through hole 23. Therefore, the liquid Q held in the through hole 23 (liquid holding space 27) is drawn to the lower opening 25 side of the through hole 23. As a result, in the sucking step of the liquid Q (see FIG. 9A), occurrence of any air gap near the lower opening 25 can be prevented. In the spotting step (see FIGS. 10A to 10C), when the liquid Q in the liquid holding space 27 is decreased by repeated spotting, the liquid Q can continue to exist on the lower opening 25 side (edge side) of the through hole 23. Thus, more reliable spotting can be realized.

When the liquid holding portion 21 is in cylindrical shape having a uniform outer diameter dimension, processing of the spot pin is relatively easy, which is advantageous from the viewpoint of productivity. The liquid holding portion 21 is in cylindrical shape having a uniform outer diameter dimension and the through hole 23 is tapered in such a manner that its diameter is decreased toward the spotting surface 22. Therefore, the wall thickness of the liquid holding portion 21 is increased toward the spotting surface 22. Accordingly, the mechanical strength of the edge of the liquid holding portion 21 on which a large load acts when the liquid Q is spotted onto the spotted object 10 can be sufficiently secured. When spotting is repeated, the edge shape of the spot pin is hard to change. Thus the shape and diameter of spotting can be stabilized for a long time.

As shown in FIGS. 4, 5, and 7, the outside air communication hole 24 discharges the gas in the liquid holding space 27 and functions as the upper limit position definition portion for defining the upper limit position of the liquid Q held in the liquid holding space 27. The outside air communication hole 24 is formed as a through hole penetrated in a radius direction of the liquid holding portion 21, is communicated with the liquid holding space 27, and is opened outside in the circumferential surface of the liquid holding portion 21. The outside air communication hole 24 is circular in cross section and is tapered in such a manner that its cross-sectional area is made larger outward. A dimension D4 of the portion opened in the liquid holding portion 21 is set to, e.g., 1 to 10 mm. The portion of the outside air communication hole 24 having the smallest width dimension viewed in the axial direction is equal to an inner diameter D5 of the liquid holding space 27.

The outside air communication hole 24 of the spot pin 2 discharges the gas in the liquid holding space 27. Thus, the capillary action in the liquid holding space 27 is limited by the outside air communication hole 24 so as to suck up the liquid Q to the lower end of the outside air communication hole 24. That is, the through hole 23 functions as the liquid holding space 27 in which the space between the lower opening 25 of the through hole 23 and the lower end of the outside air communication hole 24 can hold the liquid Q. As compared with the spot pin 2 discharging the gas in the through hole 23 from the upper opening 28 of the through hole 23, the amount of sucking of the spot pin can be stabilized in sucking up the liquid Q (see FIG. 9A). The portion of the outside air communication hole 24 having the smallest width dimension viewed in the axial direction is equal to the inner diameter D5 of the liquid holding space 27. Thus, the inner surface of the through hole 23 in the forming position of the outside air communication hole 24 is greatly missing. The capillary force occurring in the missing portion (outside air communication hole 24) can be appropriately decreased and the force moving the liquid Q above the outside air communication hole 24 can be suppressed more appropriately. Accordingly, movement of the liquid Q can be appropriately stopped at the lower end of the outside air communication hole 24.

When movement of the liquid Q can be appropriately stopped at the lower end of the outside air communication hole 24, in the state that the liquid holding space 27 is filled with the liquid Q, movement of the gas upwardly of the liquid holding space 27, that is, occurrence of the capillary force directed upwardly of the liquid holding space 27 can be prevented. Thus, occurrence of any air gap and variation in the amount of spotting can be prevented.

The spot pin 2 can stabilize the amount of the liquid Q held in the liquid holding space 27 by defining the upper limit position of the liquid Q with the outside air communication hole 24. When the amount of the liquid Q held in the spot pin 2 is stabilized, the amount of the liquid Q held in the liquid holding space 27 by one operation can be closer to an amount necessary for achieving a predetermined number of times of spotting. Therefore, the disadvantage caused when the held liquid Q is excessive can be prevented. That is, occurrence of variation in the amount of spotting due to an excessive amount of spotting can be prevented. When the kind of the liquid Q to be spotted is changed in the spot pin 2, the amount of the liquid Q remaining in the spot pin 2 is decreased. Thus, the amount of the liquid Q to be wasted is decreased, which is economically advantageous.

Such spot pin 2 can be formed by being molded in target shape using ceramic material for sintering. Examples of the ceramic material usable in the present invention include zirconia ceramics and alumina ceramics. From the viewpoint of the strength and elastic deformability, zirconia ceramics is preferably used. The spot pin 2 can be formed using a material other than ceramics, e.g., stainless steel or glass.

The spot pin 2 may be formed to have translucency. The spot pin 2 having translucency can be formed by using the zirconia ceramic material to set the wall thickness of the spot pin 2 to 0.03 to 0.5 mm or using a glass material. Here, the term “translucency” for the portion having translucency in the liquid holding portion 21 means a characteristic of visually checking the presence (amount) of the liquid Q in the liquid holding portion 21. Such translucency can be achieved in such a manner that at least part of the liquid holding portion 21 has a visual transmissivity of 3% or above. Accordingly, when the translucency is given to the spot pin 2 in this manner, the height and position (amount) of the liquid Q held in the liquid holding space 27 can be optically checked. Thus, the processing management and the quality management in the sucking-up step and the spotting step are enabled.

The portion having the translucency is formed of zirconia ceramics and its wall thickness is set in the range of 0.03 to 0.5 mm. Accordingly, the height and position (amount) of the liquid Q held in the liquid holding space 27 can be sufficiently visually checked and the mechanical strength and the elastic deformability of the spot pin 2 itself can be sufficiently secured. When the entire spot pin 2 is formed of zirconia ceramics, the mechanical strength and the elastic deformability of the entire spot pin 2 can be sufficiently secured. The spot pin 2 has sufficient durability to a large load acting in repeated spotting. Therefore, occurrence of any damage to the spot pin 2 itself can be prevented for a long time and occurrence of change in the shape of the edge of the spot pin 2 can be prevented. Thus, the shape and diameter of spotting which are stable for a long time can be maintained.

As shown in FIG. 4, the head 3 holds the plurality of spot pins 2 and interposes a pair of spacers 32 and 33 between a pair of plates 30 and 31 to define a distance between the pair of plates 30 and 31. A block 34 for connecting the head 3 to the Z-axis driving mechanism 50 is fixed to the plate 30. The plates 30 and 31 are formed with a plurality of through holes 35 and 36 into which the liquid holding portion 21 is inserted. In the head 3, the engaging portion 20 of the spot pin 2 is engaged to the peripheral portion of the through hole 23 of the plate 30 and the spot pin 2 is held in the state that it is inserted into both the through holes 35 and 36. That is, the spot pins 2 are held on the head 3 so as to be relatively moved in a Z direction.

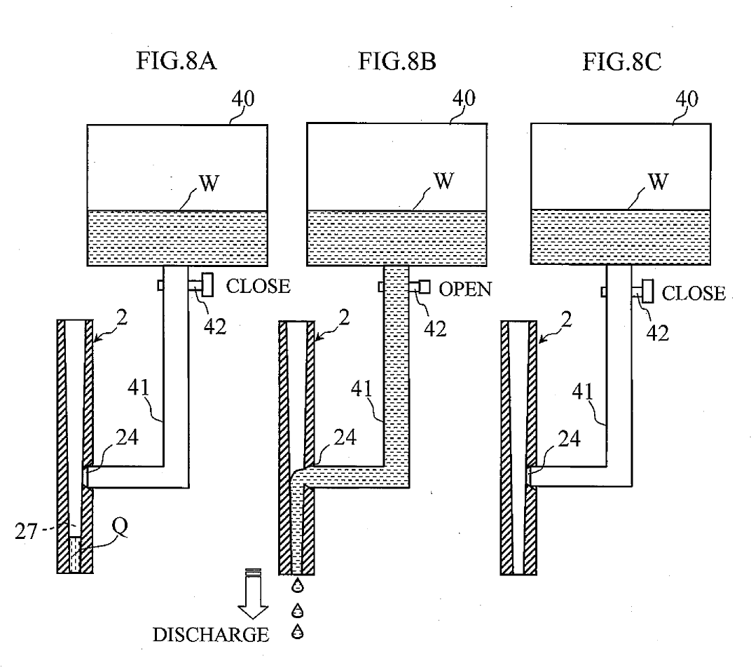

As shown in FIG. 8, the liquid supply mechanism 4 supplies the liquid Q such as a washing solution into the liquid holding space 27 of the spot pin 2 and is integral with the XY-axis driving mechanism 51. The liquid supply mechanism 4 has a washing tank 40, a tube 41, and an on-off valve 42.

The washing tank 40 houses a washing solution W to be supplied to the spot pin 2, e.g., alcohol or pure water.

The tube 41 configures a channel for supplying the washing solution W housed in the washing tank 40 to the spot pin 2, is connected to the washing tank 40, and can be connected to the outside air communication hole 24 of the spot pin 2. The inside of the washing tank 40 can be communicated with the liquid holding space 27 of the spot pin 2 via the tube 41.

The on-off valve 42 selects the state that the inside of the washing tank 40 is communicated or not with the inside of the liquid holding space 27, that is, the state that the washing solution W housed in the washing tank 40 can be supplied or not into the liquid holding space 27. The on-off valve 42 is provided midway the tube 41.

The tube 41 of the liquid supply mechanism 4 is connected to the outside air communication hole 24 of the spot pin 2 and the on-off valve 42 is opened. Thus, the liquid holding space 27 is communicated with the inside of the washing tank 40. In this state, the washing solution W of the washing tank 40 can be supplied into the liquid holding space 27 via the tube 41.

The Z-axis driving mechanism 50 shown in FIG. 1 moves the head 3 and the plurality of spot pins 2 held on the head 3 in the Z direction (the axial direction of the spot pin 2) and is coupled to the head 3 via the block 34 (see FIG. 4). The Z-axis driving mechanism 50 can be configured of a known mechanism.

The XY-axis driving mechanism 51 moves the head 3 and the plurality of spot pins 2 held on the head 3 in an XY direction and is coupled to the Z-axis driving mechanism 50. The XY-axis driving mechanism 51 can also be configured of a known mechanism.

The stage 52 with the plurality of spotted objects 10 onto which a reagent is spotted placed thereon can be moved in the XY direction. The stage 52 is not necessarily moved in the XY direction.

The control unit 53 controls opening and closing of the on-off valve 42 of the liquid supply mechanism 4 and the operation of the Z-axis driving mechanism 50, the XY-axis driving mechanism 51, and the stage 52. The control unit 53 includes a circuit having a CPU, ROM, and RAM.

The spotting liquid holding portion 54 holds the liquid Q on the spotted object 10 and, as shown in FIGS. 1 and 9A, has a plurality of spotting liquid holding tanks 54A corresponding to arrangement of the plurality of spot pins 2. The liquid Q held in the spotting liquid holding tanks 54A is a reagent including probe DNA and a solvent. The probe DNA is a substance allowing specific combination with a target. Examples of the target include hormones, tumor marker, enzyme, antibody, antigen, abzyme, other proteins, nucleic acid, cDNA, DNA, and mRNA, which are substances derived from a living body. They are extracted and isolated from the living body so as to be subject to chemical treatment and chemical modification. Without being particularly limited, any solvent which cannot affect the probe DNA can be used. Pure water or dimethylsulfoxide can be used as an example.

The liquid Q to be held in the spotting liquid holding portion 54 can be variously changed according to an object. A reagent including a probe other than DNA can be held. When the spot device 1 is used for spotting a liquid other than the reagent, a cartridge having a liquid holding tank holding the liquid according to its object can be used.

The washing portion 55 holds the washing solution for washing the spot pin 2. The washing portion 55 holds the washing solution for preventing fixing of the reagent to the spot pin 2, particularly, the inner surface of the through hole 23. As the washing solution, pure water, buffer solution, or alcohol is used. The washing portion 55 may supply ultrasonic wave or may wash the spot pin 2 by supply of ultrasonic wave. An air blower or a warm-air heater may be arranged to forcefully dry the washed spot pin 2.

The spotting operation (forming operation of a specimen fixing film 14 onto the biochip 11) of the liquid Q (reagent) onto the spotted object 10 using the spot device 1 and the washing operation of the spot pin 2 will be described.

The spotting operation of the liquid Q includes the sucking and holding step of the liquid Q in the liquid holding space 27 of the spot pin 2 and the spotting step of the liquid Q.

As shown in FIGS. 1 and 9A, the sucking and holding step of the liquid Q is performed by immersing the spotting surface 22 of the spot pin 2 into the liquid Q held in the spotting liquid holding tank 54A.

More specifically, the XY-axis driving mechanism 51 shown in FIG. 1 is controlled by the control unit 53 and each of the spot pins 2 is positioned just above the corresponding spotting liquid holding tank 54A. Then, the Z-axis driving mechanism 50 is controlled by the control unit 53. As shown in FIG. 9A, each of the spot pins 2 is immersed into the liquid Q in the corresponding spotting liquid holding tank 54A for a fixed time so as to be pulled up. In this case, when the spotting surface 22 is immersed into the liquid Q, the liquid Q is sucked in the liquid holding portion 21 by the capillary force exerted in the liquid holding space 27 and is then held in the liquid holding portion 21.

As described above, in the spot pin 2, the liquid holding space 27 is communicated with outside via the outside air communication hole 24 and the through hole 23 (liquid holding space 27) is tapered in such a manner that its cross-sectional area is made smaller toward the spotting surface 22. Therefore, a target amount of the liquid Q can be appropriately sucked in the liquid holding space 27. In sucking of the liquid Q, occurrence of any air gap and air bubble near the spotting surface 22 can be prevented.

As shown in FIG. 9B, the liquid Q may be supplied into the liquid holding space 27 of the spot pin 2 via the outside air communication hole 24. The liquid Q reserved in a case 6 may be put through the outside air communication hole 24 into the liquid holding space 27 using a liquid moving mechanism such as a tube. In this case, the liquid Q is sucked in the liquid holding space 27 by the capillary action in the liquid holding space 27. When the sucked liquid Q reaches the lower opening 25 of the through hole 23 (liquid holding space 27), the capillary action is prevented to hold a fixed amount of the liquid Q in the liquid holding space 27.

As shown in FIGS. 10A to 10C, the spotting step of the liquid Q is performed by bringing the spot pin 2 holding the liquid Q into contact with the target portion of the spotted object 10 so as to be separated therefrom.

More specifically, the XY-axis driving mechanism 51 is controlled by the control unit 53. Each of the spot pins 2 is positioned just above the corresponding target portion of the spotted object 10. Then, the Z-axis driving mechanism 50 is controlled by the control unit 53. Each of the spot pins 2 is brought into contact with the corresponding target portion for a fixed time so as to be pulled up. As shown in FIGS. 10A and 10B, when the spotting surface 22 of the spot pin 2 is brought into contact with the target portion of the spotted object 10, part of the liquid Q in the liquid holding space 27 is brought into contact with the target portion of the spotted object 10. The liquid Q is spread to the range corresponding to the outer diameter of the spotting surface 22 by the capillary action due to a slight gap caused between the spotting surface 22 and the target portion of the spotted object 10. As shown in FIG. 10C, when the spot pin 2 is raised so as to be separated from the spotted object 10, the liquid Q is spotted in the region of the diameter substantially matched with the outer diameter of the spotting surface 22 onto the target portion of the spotted object 10.

Spotting of such liquid Q is repeated plural times for one sucking of the liquid Q. As described above, the capillary force greatly acts in the portion in the liquid holding space 27 closer to the spotting surface 22. In spotting of the liquid Q, when the liquid Q is gradually decreased from the liquid holding space 27, the liquid Q is drawn to the spotting surface 22 side so as to continue to exist. Thus, reliable spotting can be realized.

When the spot pin 2 is used, variation in the amount of spotting can be prevented. Accordingly, when the spot pin 2 is used to manufacture the unit for biochemical analysis, such as the biochip 11 (see FIGS. 2 and 3), the amount of the liquid (reagent) Q fixed to the spotted object 10 (substrate 12) can be stabilized. Therefore, in the unit for biochemical analysis obtained by spotting of the reagent using the spot pin 2, variation in the amount of the fixed reagent is less and the measurement accuracy becomes high.

The washing operation of the spot pin 2 includes the moving step of the head 3 and the control step of the on-off valve 42.

The moving step of the head 3 is performed in such a manner that the XY-axis driving mechanism 51 and the Z-axis driving mechanism 50 are controlled by the control unit 53 so as to move the head 3 (spot pin 2) toward the liquid supply mechanism 4 (see FIG. 1), and then, as shown in FIG. 8A, the outside air communication hole 24 of the spot pin 2 is coupled to the tube 41. The outside air communication hole 24 is formed with a wide-mouthed taper. In this case, the tube 41 can be appropriately coupled to the outside air communication hole 24.

The on-off valve 42 is typically closed so as not to leak the washing solution W housed in the washing tank 40. As shown in FIG. 8B, the on-off valve 42 is opened by the control unit 53. Accordingly, the washing solution W in the washing tank 40 is supplied into the liquid holding space 27 via the tube 41. Part of the liquid Q typically remains in the liquid holding space 27 of the spot pin 2 (see FIG. 8A). The remaining liquid Q is forcefully discharged from the lower opening 25 of the through hole 23 (liquid holding space 27) together with the washing solution W. The washing solution W may be supplied from the washing tank 40 by its own weight of the washing solution W housed in the washing tank 40 or by using a liquid supply mechanism such as a pump.

When an appropriate amount of the washing solution W is supplied into the liquid holding space 27, the on-off valve 42 is closed by the control unit 53 so as to stop supply of the washing solution W. At this time, the washing solution W remains in the liquid holding space 27. The inside and the outside of the spot pin 2 are dried using an air blower or a warm-air heater, not shown. As shown in FIG. 8C, the spot pin 2 is thus recovered to the clean state which does not hold the liquid Q and the washing solution W.

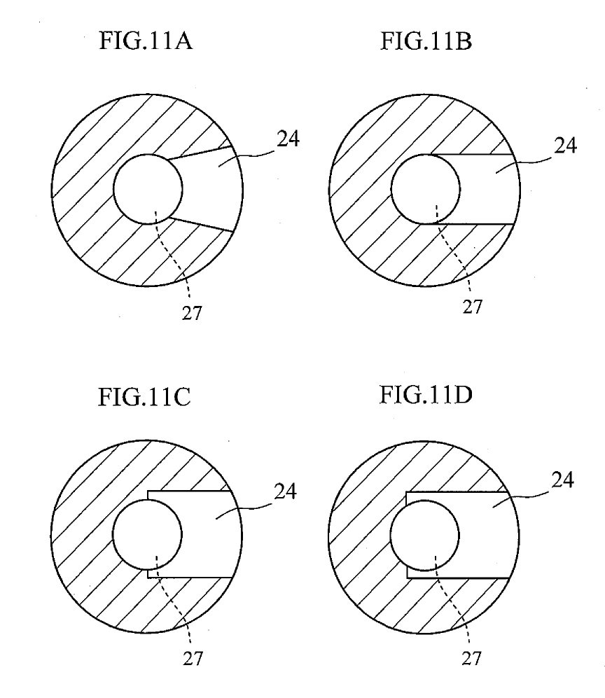

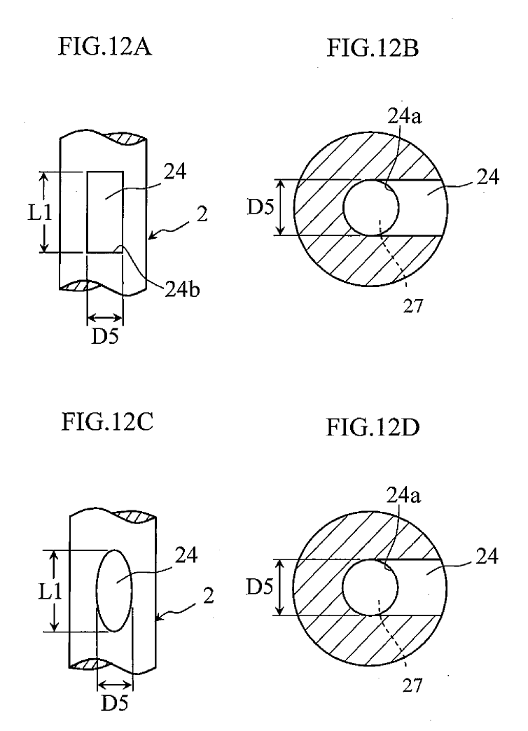

The spot pin according to the present invention is not limited to the above-described embodiment and can be modified in various ways. The outside air communication hole may be of the form as shown in FIGS. 11A to 11D and 12A to 12D.

The outside air communication hole 24 shown in FIG. 11A is tapered in such a manner that its portion having the smallest width dimension is made smaller than the diameter of the liquid holding space 27. The outside air communication holes 24 shown in FIGS. 11A to 11D are formed to have a uniform width dimension. FIG. 12B shows the outside air communication hole 24 having a width dimension equal to the diameter of the liquid holding space 27 and FIG. 11C shows the outside air communication hole 24 having a width dimension larger than the diameter of the liquid holding space 27.

The outside air communication holes 24 shown in FIGS. 12A and 12B have a rectangular cross-sectional shape. The outside air communication holes 24 shown in FIGS. 12C and 12D have an elliptical cross-sectional shape. In the outside air communication holes 24 shown in these drawings, a dimension L1 of an inside opening 24a of the spot pin 2 in the axial direction is larger than the dimension (width dimension) D5 in the direction crossing the axial direction. The dimension L1 in the axial direction is, e.g., 1 to 10 mm and the width dimension D5 is, e.g., 0.01 to 1 mm. The spot pin 2 having the outside air communication holes 24 can appropriately prevent occurrence of any air gap. As understood with reference to FIG. 5, when the dimension L1 of the outside air communication hole 24 in the axial direction is large, the capillary force does not substantially occur in the portion of the outside air communication hole 24 and the force moving the liquid Q above the outside air communication hole 24 can be suppressed. Accordingly, when the liquid holding space 27 is filled with the liquid Q and the spot pin 2 immersed into the liquid Q is pulled out, the possibility of sucking the gas in the liquid holding space and the amount of the gas to be sucked are significantly reduced. The outside air communication holes 24 shown in FIGS. 12A and 12B have a rectangular cross-sectional shape. A lower end 24b of the inside opening 24a of the outside air communication hole 24 is formed in linear shape crossing the axial direction of the spot pin 2, viewed in the penetration direction of the outside air communication hole 24. Therefore, At the lower end 24b of the inside opening 24a of the outside air communication hole 24, movement of the liquid Q above the lower end 24b of the inside opening 24a of the outside air communication hole 24 can be prevented more reliably.

In place of supplying the washing solution W into the spot pin 2 using the liquid supply mechanism 4, the specimen solution or the reagent can be supplied to the spot pin 2 using the liquid supply mechanism 4.

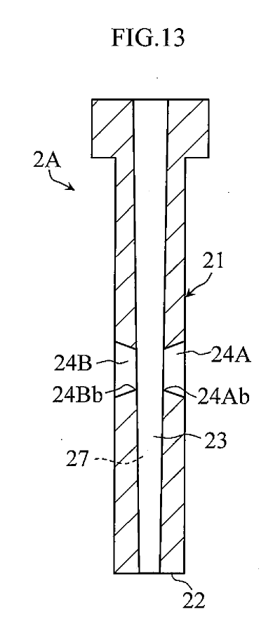

A second embodiment of the present invention will be described with reference to FIG. 13. In FIG. 13, the same elements as those of the above-described first embodiment are indicated by similar reference numerals. The overlapped description will be omitted below.

A spot pin 2A shown in FIG. 13 has two outside air communication holes 24A and 24B. The outside air communication holes 24A and 24B are opposite each other. Lower ends 24Ab and 24Bb of the inside opening have the same height. The shapes of the outside air communication holes 24A and 24B may be similar or different.

In such spot pin 2A, the inner surface of the through hole 23 forming the upper end position in the liquid holding space 27 can be greatly missing. Therefore, at the lower ends of the outside air communication holes 24A and 24B, movement of the liquid Q held in the liquid holding space 27 can be appropriately stopped, the amount of the liquid held in the liquid holding space 27 can be stabilized, and occurrence of any air gap can be prevented. When the outside air communication holes 24A and 24B opposite each other are provided, the inner surface of the liquid holding portion 21 can be greatly missing, the inner surface is cut into two regions, and the area of the inner surface is made smaller. In the state that the liquid Q is held in the liquid holding space 27 (see FIG. 9B), the liquid Q is hard to move up along the inner surface (see FIG. 9B). As a result, after the liquid Q is held in the liquid holding space 27 (see FIG. 9B), upward movement of the liquid Q in the liquid holding space 27 (see FIG. 9B) can be appropriately prevented. Sucking of the air in the lower end in the liquid holding space 27 can be prevented.

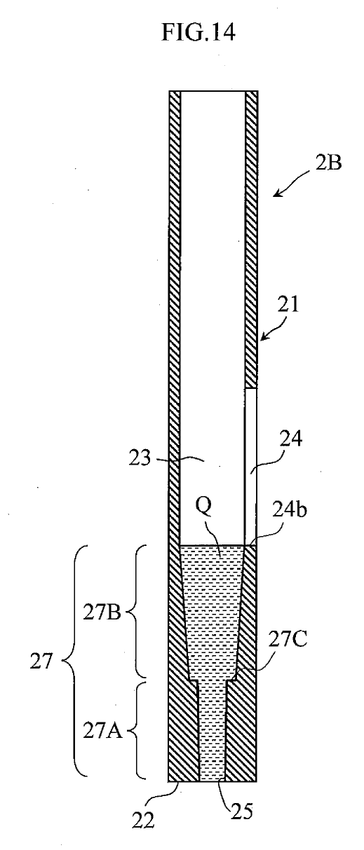

A third embodiment of the present invention will be described with reference to FIG. 14. In FIG. 14, the same elements as those of the above-described first embodiment are indicated by similar reference numerals. The overlapped description will be omitted below.

In a spot pin 2B shown in FIG. 14, the liquid holding space 27 includes a first reserving space 27A and a second reserving space 27B. The first and second reserving spaces 27A and 27b are provided by giving a step 27C on the inner surface of the through hole 23. That is, the first reserving space 27A is defined as a space from the lower opening 25 to the step 27C of the through hole 23. The second reserving space 27B is defined as a space from the step 27C to the lower end 24b of the outside air communication hole 24.

The first reserving space 27A is tapered in such a manner that its cross-sectional area is made smaller toward the lower opening 25 of the through hole 23. The second reserving space 27B has a cross-sectional area larger than that of the first reserving space 27A and is tapered in such a manner that its cross-sectional area is made larger toward the lower end 24b of the outside air communication hole 24 from the step 27C. The first and second reserving spaces 27A and 27B may have a uniform cross section.

When the liquid holding space 27 has the first and second reserving spaces 27A and 27B, a large amount of the liquid Q held in the second reserving space 27B can be secured and a large amount of the liquid Q held in the entire liquid holding space 27 can be secured. The number of times of spotting executed by one sucking can be increased. In the portion of the first reserving space 27A, the large wall thickness of the liquid holding portion 21 can be secured. Thus, the mechanical strength of the edge of the spot pin 2B (liquid holding portion 21) on which a large load acts at spotting of the liquid Q can be sufficiently secured. As a result, when spotting is repeated, the edge shape of the spot pin B2 is hard to change. Thus, the shape and diameter of spotting can be stabilized for a long time and the large number of times of spotting executed with the liquid Q held in the liquid holding space 27 can be secured. Therefore, the number of times the liquid Q is held in the spot pin 2B (liquid holding space 27) (the number of times of sucking of the liquid Q) can be reduced so as to improve operability.

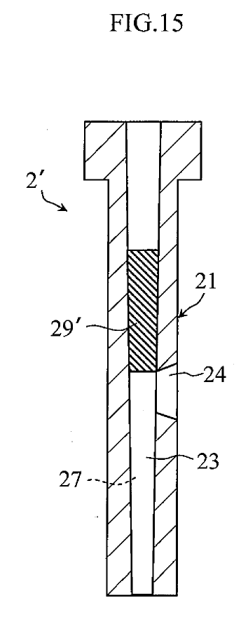

A fourth embodiment of the present invention will be described with reference to FIG. 15. In FIG. 15, the same elements as those of the above-described first embodiment are indicated by similar reference numerals. The overlapped description will be omitted below.

In a spot pin 2′ shown in FIG. 15 according to the spot pin 2 (see FIG. 5) according to the first embodiment of the present invention, a seal member 29′ is arranged in the through hole 23. The seal member 29′ is formed by a material having low permeability (e.g., rubber excellent in chemical resistance). The lower end is arranged in the position matched with or substantially matched with the upper end of the outside air communication hole 24.

In the spot pin 2′, in the state that the through hole 23 (liquid holding space 27) is filled with the liquid Q, the seal member 29′ is arranged so as to prevent the liquid Q from moving upwardly of the through hole 23 (liquid holding space 27). Therefore, in the spot pin 2′, occurrence of any air gap can be prevented more reliably.

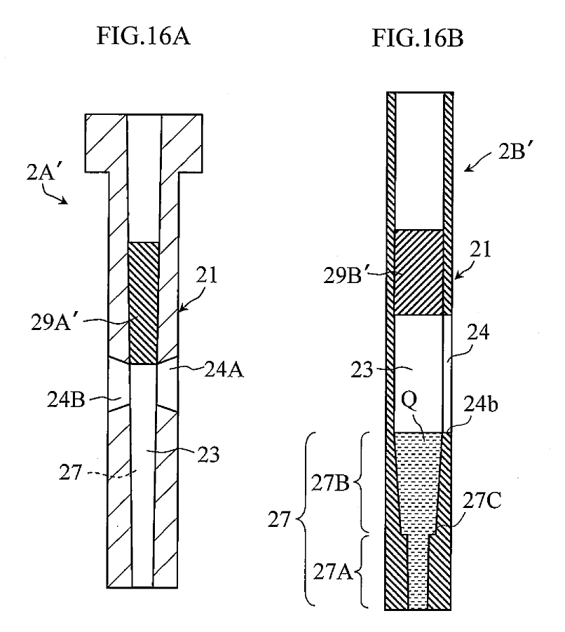

Fifth and sixth embodiments of the present invention will be described with reference to FIGS. 16A and 16B. In FIGS. 16A and 16B, the same elements as those of the above-described first embodiment are indicated by similar reference numerals. The overlapped description will be omitted below.

In a spot pin 2A′ shown in FIG. 16A according to the spot pin 2A (see FIG. 13) according to the second embodiment of the present invention, a seal member 29A′ is arranged in the through hole 23. In a spot pin 2B′ shown in FIG. 16B according to the spot pin 2B (see FIG. 14) according to the third embodiment of the present invention, a seal member 29B′ is arranged in the through hole 23.

The seal member 29A′ or 29B′ in the spot pin 2A′ or 2B′ is arranged in the through hole 23. Thus, occurrence of any air gap can be prevented more reliably.

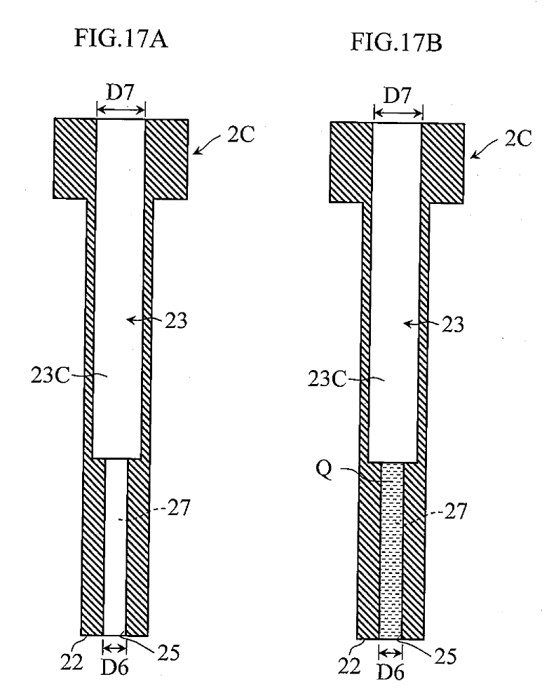

A seventh embodiment of the present invention will be described with reference to FIGS. 17A and 17B. In FIGS. 17A and 17B, the same elements as those of the above-described first embodiment are indicated by similar reference numerals. The overlapped description will be omitted below.

A spot pin 20 shown in FIGS. 17A and 17B formed in tubular shape having the through hole 23 is common to the spot pins 2, 2A, 2B, 2′, 2A′, and 2B′ (FIGS. 5 and 13 to 16) according to the above-described first to sixth embodiments and is different in the upper limit position definition portion of the spot pins 2, 2A, 2B, 2′, 2A′, and 2B′.

The through hole 23 in the spot pin 20 has the liquid holding space 27 and a large-diameter penetration portion 23C. The cross-sectional shape of the through hole 23 is circular, which is not limited to this, and can be elliptical, semicircular, triangular, square, polygonal, or star-shaped.

The liquid holding space 27 holds the liquid Q and is formed so as to exhibit the capillary force. A diameter D6 of the liquid holding space 27 is set in the range of, e.g., 0.01 to 1 mm.

The large-diameter penetration portion 23C functions as the upper limit position definition portion for defining the upper limit position of the liquid Q such as the reagent held in the liquid holding space 27. Unlike the liquid holding space 27, the large-diameter penetration portion 23C is formed so as not to exhibit the capillary force or to hardly exhibit the capillary force. Here, the wording “to hardly exhibit the capillary force” means that the capillary force is exhibited to the extent that it cannot be beyond the step between the liquid holding space 27 and the large-diameter penetration portion 23C. A diameter D7 of the large-diameter penetration portion 23C may be appropriately designed according to the surface tension or viscosity of the liquid, the wettability on the inner surface of the through hole 23, and a distance to the step between the liquid holding space 27 and the large-diameter penetration portion 23C.

In the spot pin 2C, the liquid Q such as the reagent can be sucked up from the lower opening 25 since the liquid holding space 27 exhibits the capillary force. The large-diameter penetration portion 230 is formed so as not to exhibit the capillary force. Therefore, the liquid Q sucked up from the lower opening 25 cannot be moved above the upper end position in the liquid holding space 27. As a result, in the spot pin 2C, the amount of the liquid Q sucked up once is fixed. Accordingly, the amount of the liquid Q held in the liquid holding space 27 by one operation can be closer to an amount necessary for achieving a predetermined number of times of spotting. Therefore, the disadvantage caused when the held liquid Q is excessive can be prevented. That is, an excessive amount of spotting can be prevented and occurrence of variation in the amount of spotting can be prevented. When the kind of the liquid Q to be spotted is changed in the spot pin 2C, the amount of the liquid Q remaining in the spot pin is decreased. Thus, the amount of the liquid Q to be wasted is decreased, which is economically advantageous.

In the spot pin 2C, when the liquid Q is sucked and held in the liquid holding space 27 in which the spotting surface 22 of the spot pin 2C is immersed into the liquid Q, occurrence of any air gap on the spotting surface side in the liquid holding space 27 can be prevented. When the liquid holding space 27 is filled with the liquid Q, upward movement of the liquid Q is limited by the large-diameter penetration portion 23C. Therefore, when the spot pin 2C is pulled out in the state that the spotting surface 22 of the spot pin 2C is immersed into the liquid Q to be sucked, the force attempting to suck the gas in the liquid holding space 27 is significantly reduced. Accordingly, when the spot pin 2C immersed into the liquid Q is pulled out, the possibility of sucking the gas in the liquid holding space 27 and the amount of the gas to be sucked are significantly reduced. In the operation of sucking the liquid Q in the spot pin 2C, occurrence of any air gap on the spotting surface in the liquid holding space 27 of the spot pin 2C thus can be prevented.

The spot pin 2C formed in tubular shape is harder to expose the liquid Q to outside air atmosphere (a region to be exposed is small) than the liquid holding portion 21 formed in slit shape. Accordingly, occurrence of evaporation, deterioration, and contamination of the liquid Q in the spot pin 2C can be prevented. The upper limit position definition portion is configured as the large-diameter penetration portion 23C. Thus, the above effect can be obtained by a relatively simple configuration and the liquid holding space (capillary region) 27 can be defined.

The present invention is not limited to the configuration described in the above embodiments and can be modified in various ways. The spot device 1 can be used for manufacturing, not only the biochip 11 shown in FIGS. 2 and 3, but also the biochip 11 of other form. The spot device 1 can be used, not only for manufacturing the biochip 11, but also for spotting the liquid Q onto the spotted object 10 by other objects.

In the spot pin 2C according to the seventh embodiment of the present invention, the liquid holding space 27 may be tapered so as to have the first and second reserving spaces or a protrusion surrounding the edge opening 25 in the liquid holding space 27 may be provided on the spotting surface 22.

The liquid holding space 27 is not necessarily formed as part of the through hole 23. The upper side in the liquid holding space 27 may be integrally closed by part of the liquid holding portion 21, not by the seal members 29′, 29A′, and 29B′.

### EXAMPLES

Variation in the number of times of spotting of the spot pin according to the present invention has been studied below.

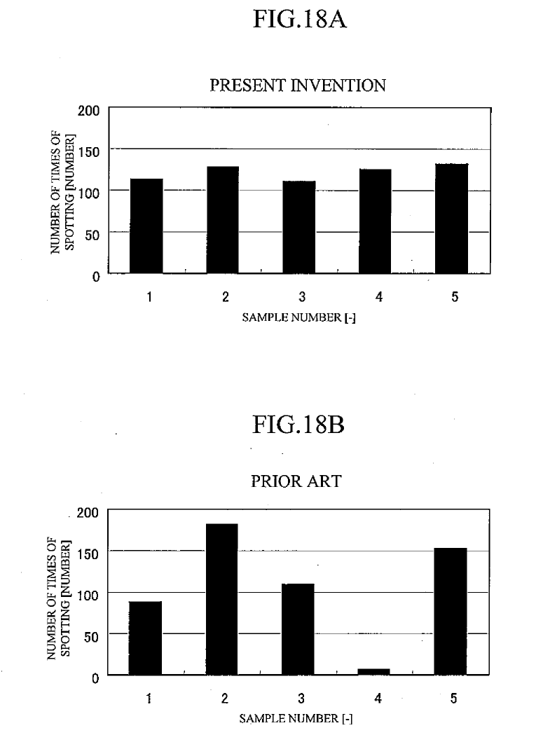

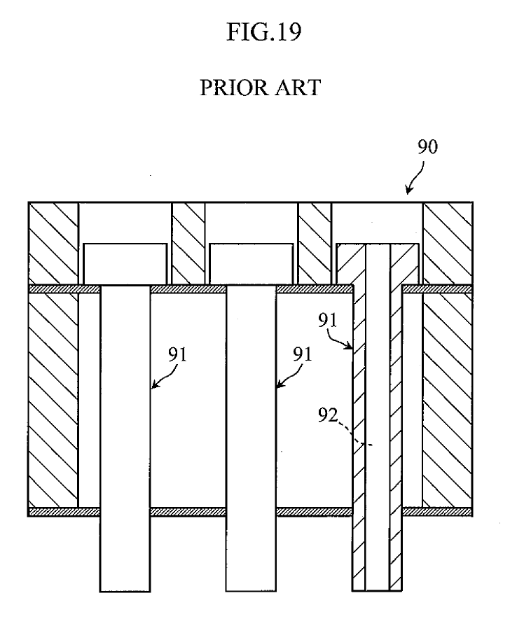

When variation in the number of times of spotting has been studied, there was used the spot pin according to the present invention having the outside air communication hole shown in FIGS. 11A and 12A, that is, having the outside air communication hole having a uniform rectangular cross section. As a comparative example, there was used the spot pin having the same configuration as that of the spot pin of the present invention except that it is not formed with the outside air communication hole. Using these spot pins, the number of times of spotting executed by one sucking was counted. Such count was performed five times. FIG. 18A shows the measured results of the number of times of spotting of the spot pin of the present invention. FIG. 18B shows the measured results of the number of times of spotting of the spot pin of the comparative example. In the graphs shown in these drawings, the vertical axis shows the number of times of spotting and the horizontal axis shows sample numbers.

As shown in FIG. 18A, for the number of times of spotting executed by one sucking in the spot pin of the present invention, there were shown 113 times for sample 1, 127 times for sample 2, 110 times for sample 3, 125 times for sample 4, and 131 times for sample 5. The number of times of spotting was substantially fixed.

As shown in FIG. 18B, for the number of times of spotting executed by one sucking in the spot pin of the comparative example, there were shown 88 times for sample 1, 181 times for sample 2, 109 times for sample 3, 6 times for sample 4, and 153 times for sample 5. The number of times of spotting was found to be greatly varied. In particular, an air gap occurred on the edge side of the sample 4, which is a major factor that the number of times of spotting is very small.

As understood from the above results, the outside air communication hole is provided in the spot pin to hold the fixed amount of the liquid in the liquid holding portion. The substantially fixed number of times of spotting executed by one sucking can be maintained.

### INDUSTRIAL APPLICABILITY

The spot pin and the spot device using the same according to the present invention are very useful in industry in that the amount of sucking can be stabilized to prevent variation in the number of times of spotting.

1. A spot pin comprising:
a liquid holding portion including a tubular portion defining a liquid holding space for holding a liquid; and
an upper limit position definition portion positioned in a middle of the liquid holding portion in an axial direction and defining the upper limit position of the liquid held in the liquid holding portion.

2. The spot pin according to claim 1, wherein the upper limit position definition portion has one or a plurality of outside air communication holes communicated with the liquid holding space and opened in the circumferential surface of the liquid holding portion.

3. The spot pin according to claim 2, wherein the outside air communication hole is penetrated in a direction crossing the axial direction and has the largest width dimension, viewed in the axial direction, equal to or larger than the inner diameter of the liquid holding portion.

4. The spot pin according to claim 2, wherein the outside air communication hole is penetrated in the direction crossing the axial direction and is tapered in such a manner that diameter of the outside air communication hole is increased outward from the liquid holding space, viewed in the axial direction.

5. The spot pin according to claim 2, wherein the plurality of outside air communication holes include first and second outside air communication holes opposite each other by interposing the liquid holding space therebetween.

6. The spot pin according to claim 2, wherein an inside opening of the outside air communication hole has a dimension in the axial direction larger than that in the direction crossing the axial direction.

7. The spot pin according to claim 2, wherein a lower end of the inside opening of the outside air communication hole is formed in linear shape crossing the axial direction, viewed in a penetration direction of the outside air communication hole.

8. The spot pin according to claim 2, further comprising a seal member arranged on the upper side in the liquid holding space.

9. The spot pin according to claim 1, further comprising a through hole penetrated in the axial direction,
the through hole including the liquid holding space for exhibiting the capillary force and a large-diameter penetration portion having a diameter in the direction crossing the axial direction larger than that of the liquid holding space and configuring the upper limit position definition portion which does not exhibit the capillary force or hardly exhibits the capillary force.

10. The spot pin according to claim 1, wherein the liquid holding space is formed in such a manner that its cross-sectional area is made smaller toward a spotting surface to be contacted with a spotted surface.

11. The spot pin according to claim 1,
wherein the liquid holding space has first and second reserving spaces,
the first reserving space being arranged so as to be closer to the spotting surface side to be contacted with the spotted surface than to the second reserving space and having a cross-sectional area in the direction crossing the axial direction smaller than that of the second reserving space.

12. The spot pin according to claim 1, wherein the wall thickness of the liquid holding portion is increased toward the spotting surface to be contacted with the spotted surface.

13. The spot pin according to claim 1, wherein at least part of the liquid holding portion has translucency.

14. The spot pin according to claim 13, wherein the portion having translucency of the liquid holding portion is formed of zirconia ceramic and the wall thickness of the portion is 0.5 mm or below.

15. The spot pin according to claim 1, wherein the entire spot pin is formed of zirconia ceramics.

16. The spot pin according to claim 1, further comprising one or a plurality of protrusions formed on the spotting surface of the liquid holding portion to be contacted with the spotted surface and surrounding an edge opening in the liquid holding space.

17. The spot pin according to claim 16, wherein the protrusion is formed in annular shape.

18. The spot pin according to claim 1, wherein the liquid holding portion is formed in cylindrical, square tubular, or elliptical tubular shape.

19. A spot device comprising:
a spot pin according to claim 1;
a moving mechanism for moving the spot pin in an axial direction; and
a control unit for controlling the operation of the moving mechanism.

20. The spot device according to claim 19, further comprising a liquid supply mechanism for supplying a liquid into the liquid holding space via the upper limit position definition portion when the upper limit position definition portion is formed by an outside air communication hole communicated with the liquid holding space and opened in a circumferential surface of the liquid holding portion.

21. The spot device according to claim 20, wherein the liquid is a specimen solution, reagent, or washing solution.

22. A liquid spotting method comprising the steps of:
holding a liquid in a liquid holding space of a spot pin according to claim 1; and
bringing a spotting surface of the spot pin into contact with a spotted surface to separate the spotting surface from the spotted surface for spotting the liquid in the liquid holding space onto the spotted surface.

23. The liquid spotting method according to claim 22, further comprising the step of discharging the liquid remaining in the liquid holding space after the spotting step.

24. A method of manufacturing a unit for biochemical analysis, which fixes a reagent onto a substrate, comprising the steps of:
holding the reagent in a liquid holding space of a spot pin according to claim 1; and
bringing a spotting surface of the spot pin into contact with the surface of the substrate to separate the spotting surface from the substrate for spotting the reagent in the liquid holding space onto the surface of the substrate.
